(19) United States
(12) Patent Application Publication
(10) Pub. No.: US 2019/0153774 A1
(43) Pub. Date: May 23, 2019

(54) OVERHEAD DOOR WITH STACKING PANELS

(71) Applicant: CornellCookson, LLC, Mountaintop, PA (US)

(72) Inventors: Joseph L. Balay, Sugarloaf, PA (US); Thomas Balay, Drums, PA (US)

(73) Assignee: CornellCookson, LLC, Mountaintop, PA (US)

(21) Appl. No.: 16/188,606

(22) Filed: Nov. 13, 2018

Related U.S. Application Data
(60) Provisional application No. 62/589,631, filed on Nov. 22, 2017.

(51) Int. Cl. E06B 9/06

(52) U.S. Cl. CPC E06B 9/0676; E06B 9/0638

(57) ABSTRACT

An overhead door having a plurality of unconnected panels. Each panel has a top and bottom edge interlocking retention geometry and end caps. The end caps engage dual track guide assemblies to completely separate the panels as the door is raised.

### CROSS REFERENCE TO RELATED APPLICATIONS

This application claims benefit of U.S. Application No. 62589631 filed Nov. 22, 2017.

### FIELD OF THE INVENTION

This invention relates generally to overhead doors, and in particular, to an overhead door with stacking panels.

### BACKGROUND OF THE INVENTION

Overhead doors are utilized to provide security and access control in institutional, industrial and commercial buildings. They fall into two general design categories: coiling doors and segmented panel doors. Each have their advantages and disadvantages making one better suited for a given design application.

Often times a segmented panel door is better suited for a particular application but cannot be used due to the increased space requirement needed to house the panels once the door is opened. Various attempts have been made to reduce the profile of the opened door.

The stacking design of many of the known panel stacking designs maintain a connection point between the panels, for example a hinge, or otherwise link the opened panels, for example, with chains, to support the weight of the panels during opening. Having to maintain a connection point between the panels presents many disadvantages such as placing limitations on the ease of repair of damaged panels and requiring higher energy consuming operators to open the door.

Accordingly, there is still a continuing need for improved stacking panel overhead door designs. The present invention fulfills this need and further provides related advantages.

### BRIEF SUMMARY OF THE INVENTION

We have previously described a stacking independent panel door in U.S. Pat. No. 8,869,450, incorporated by reference. The following disclosure describes an improved stacking panel overhead door wherein the panels are likewise independent of one another.

One advantage of independent stacking panels described herein is the spring torque to door weight ratio is easier to control than in known connected panel designs. The weight of the door continually decreases as the door is lifted and each independent panel disengages completely from its adjacent panel as it reaches the stacked position. This allows for a linear spring torque to door weight relationship requiring a smaller motor to provide the lifting torque necessary to operate the door compared to existing designs, thereby providing concomitant energy savings.

The panel end geometry can be made with molded, extruded or steel fabricated assemblies. Molded parts are used for the slides and bearings to provide more cost effective operation over existing roller bearing assemblies.

Stacking the panels vertically allows the door to fit inside the same installed size requirement as a rolling door. Further advantages are provided by matching the insulation values of common sectional doors while only requiring the installation space of a rolling product.

Still another advantage is the ease of replacement or repair of a damaged panel and the ability to re-order or install other panel options by simply removing the panels from the stack and replacing them with new or other panel options.

Other features and advantages will be apparent from the following more detailed description of the preferred embodiments, taken in conjunction with the accompanying drawings which illustrate by way of example the principles of the invention.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is a front view of a stacking door in a closed position.

FIG. 2 is a top view of the stacking door of FIG. 1.

FIG. 3 is a perspective view of the stacking door of FIG. 1.

FIG. 4 is a detail view of section BC of FIG. 3.

FIG. 5 is a side view of the stacking door of FIG. 1.

FIG. 6 is a top view of a guide assembly.

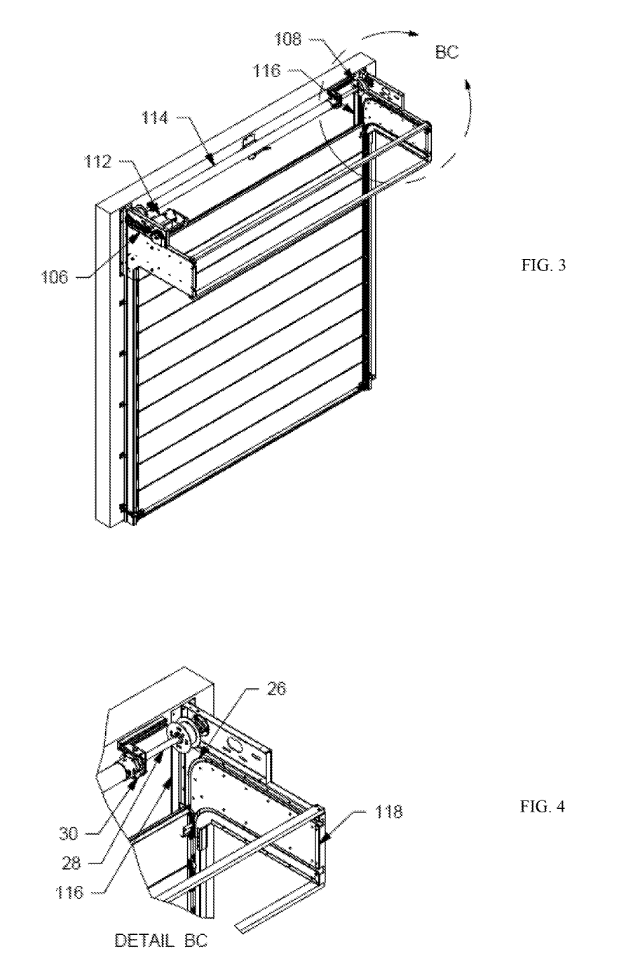

FIG. 3 is a perspective view of a panel.

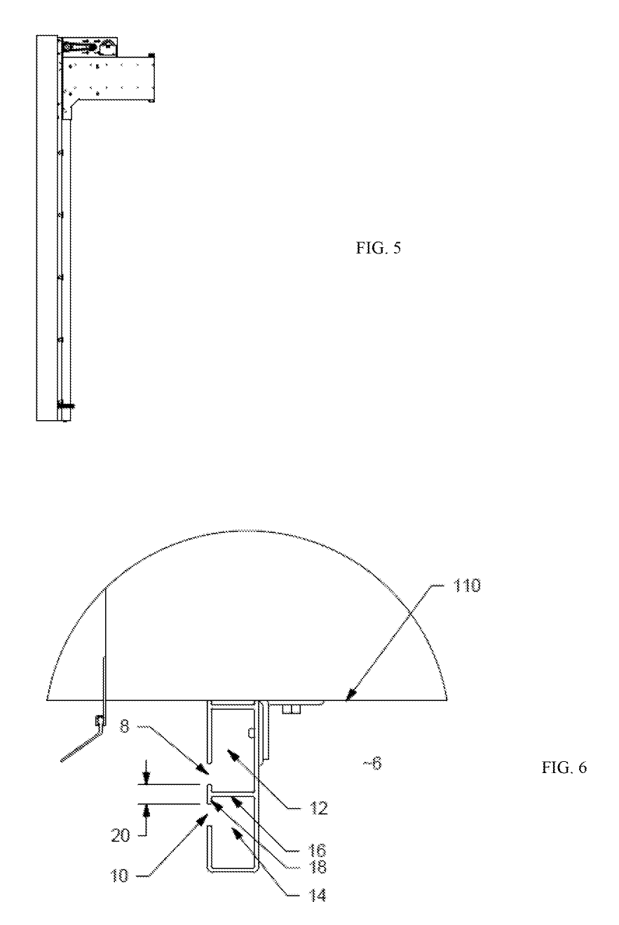

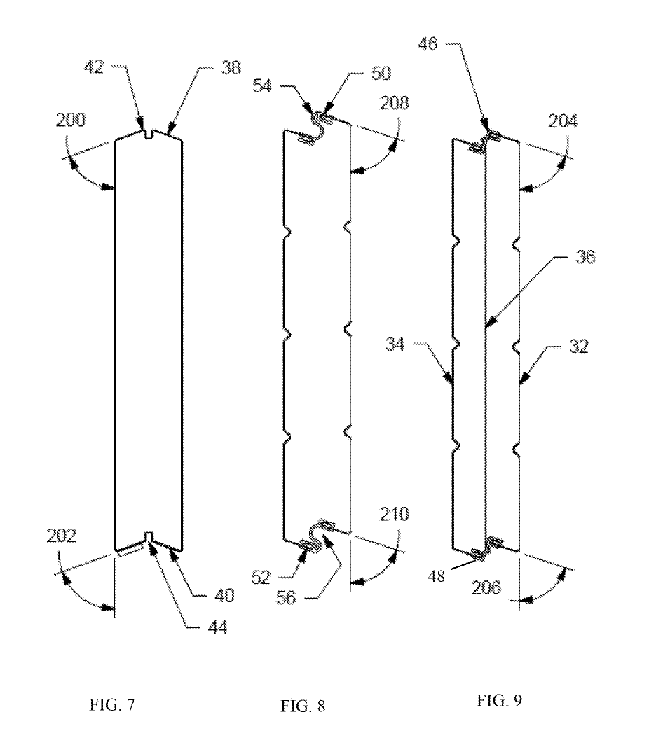

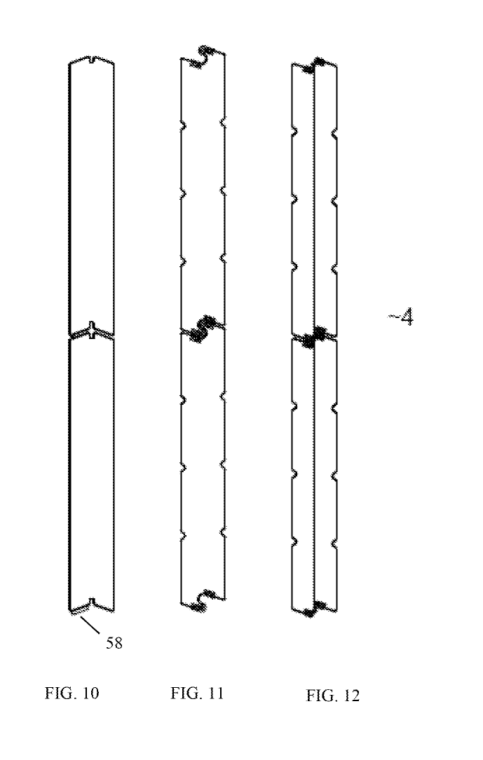

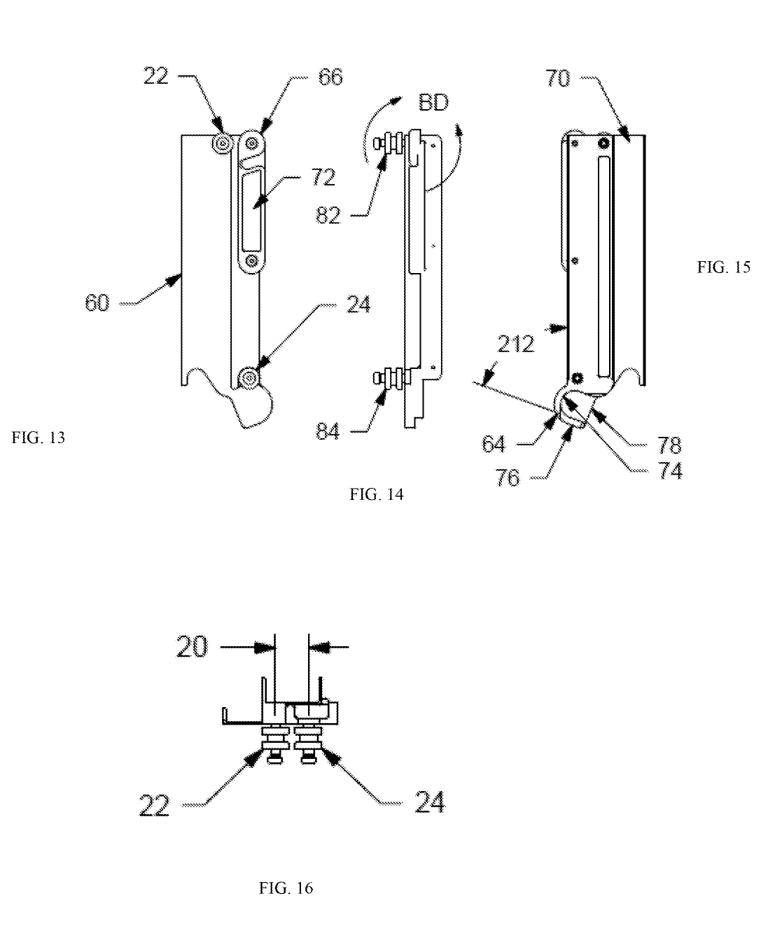

FIG. 4 is a front and side view of a panel with panel ends.

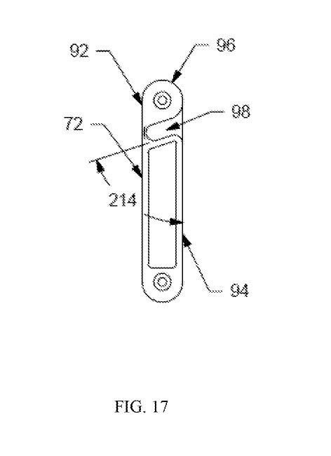

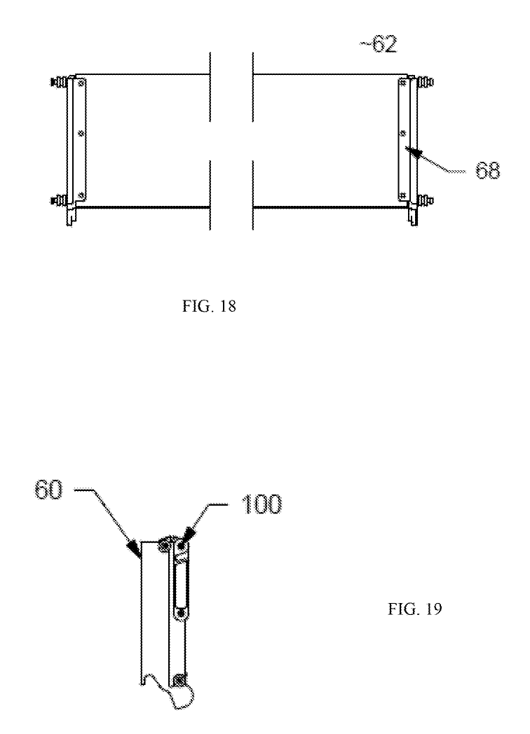

FIG. 5 is an exploded view of two panels with tongue and groove geometry.

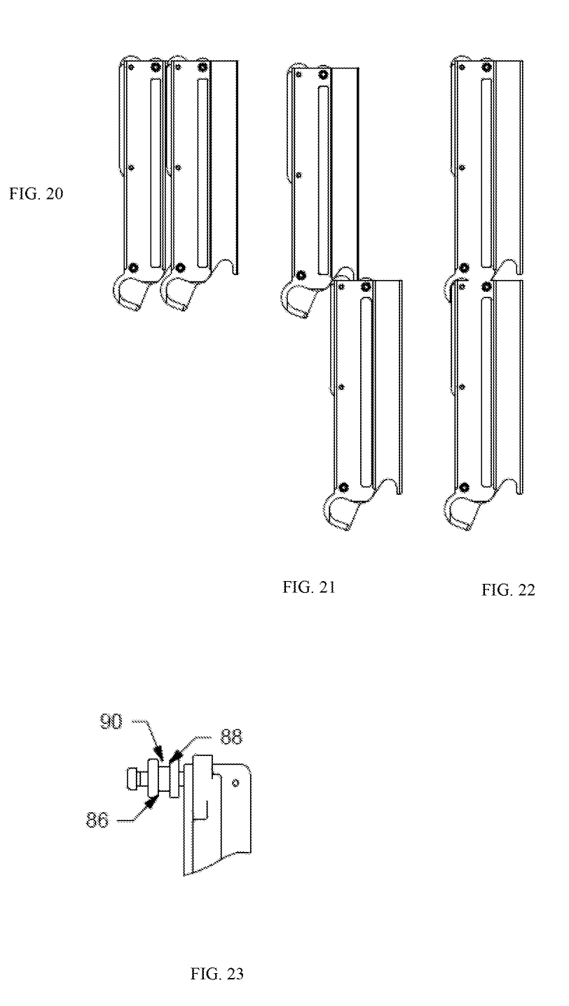

FIG. 6 is an exploded view of two panels with stepped retention geometry.

FIGS. 7-9 are a side view of a panel.

FIGS. 10-12 are side views of 2 stacked panels.

FIGS. 13 and 15 are front views of an end cap.

FIGS. 14, 16, 18 and 23 are views of bearings.

FIGS. 17 and 19 are front views of a slide member.

FIGS. 20-23 are side views of adjacent panels in various stages of operation.

### DETAILED DESCRIPTION OF THE INVENTION

As required, detailed embodiments of the present invention are disclosed; however, it is to be understood that the disclosed embodiments are merely exemplary of the invention that may be embodied in various forms. The figures are not necessarily to scale, and some features may be exaggerated to show details of particular components. Therefore, specific structural and functional details disclosed are not to be interpreted as limiting, but merely as a basis for the claims and as a representative basis for teaching one skilled in the art to variously employ the present invention. Where possible, like reference numerals have been used to refer to like parts in the several alternative embodiments described herein.

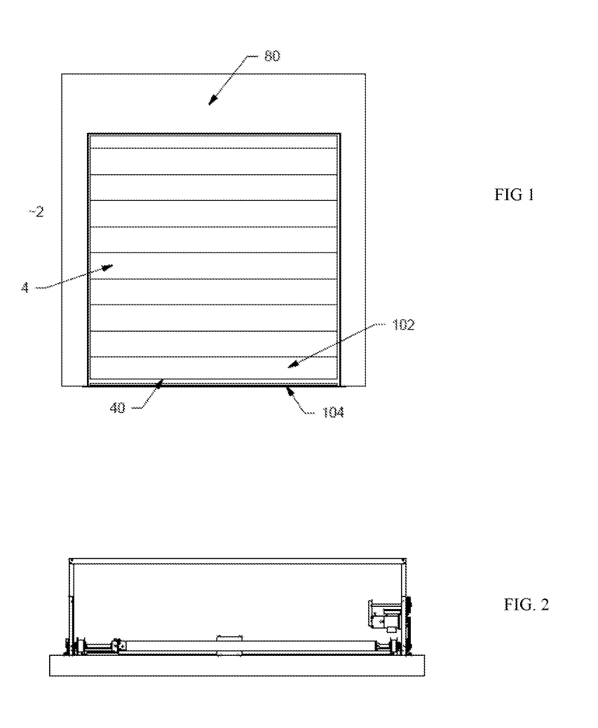

Turning now to FIGS. 1-6, in a preferred embodiment, the overhead door 2 comprises a plurality of independent panels 4 which operatively travel at each end within a respective guide assembly 6. The panels 4 are connected while in the full open position and the full closed position, described more fully below. Each guide assembly 6 comprises a first 8 and second 10 track. In a preferred embodiment the first and second track 8, 10 each comprise a first and second chamber 12, 14.

The guide assembly 6 further comprises a horizontal section 16 and a vertical section 18. In the horizontal section 16 the tracks 8, 10 are separated from one another by a distance equal to the width of a panel 4. In the vertical section 18 the tracks 8, 10 are separated from one another by an offset distance 20 between a first (superior) engagement member (bearing) 22 and a second (inferior) engagement member (bearing) 24 depicted in FIG. 16 and described below. The transition between the horizontal section 16 and the vertical section 18 is accomplished through a guide assembly radius 26.

Returning to FIG. 4, a shaft 28 comprising a tensioner 30, for example a spring, is used to offset the torque necessary to open the door 2. Because the independent panel stacking door 2 described herein loses the weight of each panel 4 once a panel separates, much less power is required to raise the door 2 than what would be necessary with a non-stacking panel door. Door operation improves with more panels in the guide assembly radius 26 but requires a larger footprint to install.

As depicted in FIGS. 7-9, each panel 4 comprises an outer 32 and inner 34 surface with preferably an insulating material 36 in-between. Optionally each panel 4 may be ribbed to give the appearance of slats. While panels of varying thickness and height are contemplated, in a preferred embodiment the panels are about 12″ in height and about 2″ thick to provide ideal insulating properties. A top 38 and bottom 40 edge each comprise a respective retention geometry 42, 44 that allows for reduced clearance during engagement and disengagement of adjacent panels 4 during operation and prevents lateral displacement of the panels when engaged.

In one form the top edge retention geometry 42 comprises a tongue. The bottom edge retention geometry 44 comprises a groove. When the door 2 is closed and two panels 4 are fully engaged (FIGS. 10-12), the tongue 42 of the first panel nests intimately within the groove 44 of its adjacent panel. The tongue 42 and groove 44 edge geometry allows adjacent panels to interlock and prevents engaged panels from separating, thereby insuring security and providing added weather protection.

Preferably, to reduce the required clearance necessary for the engagement and disengagement of adjacent panels, the tongue 42 and respective groove 44 of adjacent panels are angled from normal to the respective panel edge. Depicted in FIG. 7, angle 200 (the angulation from tongue normal) and angle 202 (the angulation from groove normal) are both about 10 degrees to about 25 degrees, preferably about 15 degrees to about 20 degrees and optimally about 18 degrees.

Alternatively, another retention geometry is a mating S shaped top edge 50 and bottom edge 52 the S shape forming a lip 54 and a trough 56 Depicted in FIG. 8, the top edge lip 54 is angled in relation to outer panel surface 32 forming lip angle 208. Likewise, the trough 56 is angled in relation to inner panel surface 34 forming trough S angle 210. For the bottom edge geometry the lip 54 is angled in relation to inner panel surface 34 forming lip angle 210. The trough 56 is angled in relation to outer panel surface 32 forming trough angle 208. When adjacent panels 4 are fully engaged (FIG. 11) the lip 54 of the first panel nests intimately within the trough 56 of its adjacent panel. The lip/trough geometry allows adjacent panels to nest and prevents engaged panels from separating. Lip and trough angles 208 and 210 are both about 10 degrees to about 25 degrees, preferably about 15 degrees to about 20 degrees and optimally about 18 degrees.

In yet another alternative, mating respective first and second panel stepped retention geometries 46, 48 as depicted in FIG. 9 may be used. To reduce the required clearance for engagement and disengagement of adjacent panels, the first panel step geometry 46 and mating second panel step geometry 48 of adjacent panels are each angled from respective panel edge normal. Mating adjacent panel step angles 204, 206 are both about 10 degrees to about 25 degrees, preferably about 15 degrees to about 20 degrees and optimally about 18 degrees.

Optionally, a thermal break piece 58 shown in FIG. 10 is attached to each panel 4 Multiple points of contact between the panel top edge thermal break piece 58 and panel bottom edge thermal break piece 58 increase the surface area of the joint to provide a more complete air infiltration seal. The thermal break piece 58 is, for example, pvc extrusions (both “s” and “square”) that connect the inside and outside face. A thermal break is also achieved by the separation in the front and back face tongue and groove design.

Turning to FIGS. 13-19, an end cap 60 is fastened to each panel end 62. The end cap 62 comprises at the inferior end an end cap retentive member 64, for example a hook geometry, and a bearing receiving geometry 66, for example scalloping. Each end cap 60 further comprises a panel fastening section 68 to receive and fasten the panel end 62, and a slide member receiving section 70 to operatively receive the adjacent panel's slide member 72 when stacked (described in detail below).

In a preferred embodiment the end cap retentive member 64 (hook geometry) comprises a hook radius 74 and an engagement leg 76. The hook geometry 64 may further comprise a web 78 to add strength. Additionally, the hook radius 74 may be stepped.

The end caps 60 provide both esthetic and operative engagement advantages. When the panels 4 are stacked the end caps 60 contact each other rather than the panel bodies, thereby reducing the bumping and potential disfigurement of the panels 4. Engagement/disengagement of the panels 4 occurs above the door header 80 (FIG. 1), thereby reducing access to pinch points and allowing for replacement panels to be added to the rear of the stack or in place of a damaged panel.

A first end cap bearing 82, a second end cap bearing 84 and the slide member 72 are fastened to each end cap 60. The first end cap bearing 82 is superior to the second end cap bearing 84. In a preferred embodiment depicted in FIG. 25 the bearings 82, 84 are generally H shaped, having a first bearing end 86 and second bearing end 88 with a bearing groove 90 therebetween. Each bearing end 86, 88 is captured by a respective first and second guide assembly track chamber 12, 14. The first and second bearing 82, 84 are horizontally offset from one another.

Returning to FIG. 17, the slide member 72 comprises an end cap retentive member engaging end 92 and an end cap retentive member receiver 94. In a preferred embodiment the retentive member engaging end 92 comprises a slide member radius 96 and the retentive member receiver comprises a slide member slot 98. The slide member 72 is fastened to the end cap 60, for example with bolts 100.

Turning to FIG. 15, a hook disengagement angle 212 is defined as the angle formed by the engagement leg 76 and vertical. A mating slide member slot angle 214 is formed by the slide member slot 98 and horizontal (FIG. 17). These angles 212, 214 are critical to proper operative engagement/disengagement of the panels 4. The hook disengagement angle 212 and the mating slide member slot angle 214 are both acute angles, preferably between about 65 degrees and about 75 degrees, most preferably about 70 degrees and about 72 degrees, respectively.

All panels 4, including the bottom panel 102 are interchangeable to allow for easy removal of a damaged panel and replacement. The bottom panel 102 (FIG. 1) may include a removably attached weather seal and/or sensing edge 104 affixed to its bottom edge 40 that is removed and then reattached to the replacement bottom panel. The bottom panel 102 is operatively engaged to a drive mechanism 106 (FIG. 3), for example a cable, chain, belt, strap, or piston; preferably a strap. The drive mechanism 106 operatively wraps on a powered drum 108 to raise and lower the bottom panel 102.

Depicted in FIGS. 20-22, the end cap retentive member (hook geometry) 64 operatively engages the slide member end cap retentive member engaging end (slide member radius) 92 of the adjacently inferior panel during opening and closing of the door 2. When fully operatively engaged the end cap retentive member engagement leg 76 is seated within the slide member slot 98 of the adjacently inferior panel.

A respective guide assembly is fixed to each side of a door opening frame member 110 in known fashion. In operation of a preferred embodiment, to close the overhead door 4 a power generator, for example, a motor 112 turns a shaft 114 in a direction to unwind the strap 116 from the drum 108 attached to the shaft 114. The bottom panel 102 gravity closes as the strap 116 unwinds. The bottom panel 102 maintains the panel immediately superior to it in the panel stack until the point of transition to the engaged position. As the first engagement member 22 and second engagement member 24 of adjacent panels become engaged, the process begins again as the newly engaged panel maintains its immediately superior panel in the panel stack until the point of transition to the engaged position. The stacked panels move forward and the process repeats until all of the panels necessary to close the opening are in place.

To open the door 2 the opposite occurs. As the motor 112 turns the shaft 114 winding the strap 116 onto the drum 108 the bottom panel 102 is raised thereby raising all the panels above it. As a panel 4 travels through the two guide assembly radius 26, the end cap retentive member 64 (hook geometry) shifts around the slide member engaging end 96 (slide member radius) disengaging the adjacent panels from one another and allowing them to stack and travel horizontally during the opening process, see FIGS. 20-22 (left to right-close direction, right to left-open direction). As they stack, the adjacently inferior panel slide member operatively engages the end cap slide member receiving section of the adjacently superior panel. It is this operative engagement that allows the stacked adjacently inferior panel to pull its operatively engaged stacked adjacently superior panel forward (thereby unstacking) during the door closing process.

The end cap bearing receiving geometry 66 (scalloping) of the adjacently superior panel receives the second (inferior) bearing 84 of the adjacently inferior panel. This in combination with the offset first (superior) bearing 82 allows the panels 4 to nest when stacked. The slide 72 provides greater stability during operation than using only bearings.

The panels 4 are connected while in the full open position and the full closed position. This is shown in FIGS. 20-22: step 1 open position, step 2 unconnected, engaging position, step 3 closed position. Each panel is independent from and unconnected to one another in the bottom of the guide assembly radius 26, therefore, repair or replacement is easily and quickly accomplished. For example, in the door open position each independent stacked panel or a group of panels can be slid out the rear of the stack until the damaged panel is retrieved. Once repaired or replaced, the removed panels are easily and quickly replaced within the guide assembly bracket 118. No time is lost to removing hinges or otherwise disconnecting and reconnecting one panel to adjacent panels as is required with non-stacking technology.

This option also improves the ease of installation of the door by allowing each panel to be loaded independently or together depending upon the equipment available. By installing the bottom panel and connecting the lifting mechanism the spring can be tensioned with minimal torque before adding the other panels. This varies from current sectional doors whereby requiring all panels to be installed in the opening before the spring torque is applied. Full operational torque is applied at this point with sectional doors.

The vertical operation of the door allows for multiple height doors openings to be closed off using the same number of panels and not requiring different panel heights to close the opening. Currently some sectional doors require various panel heights, tracks and bearing assemblies to close door openings.

Although the present invention has been described in connection with specific examples and embodiments, those skilled in the art will recognize that the present invention is capable of other variations and modifications within its scope. These examples and embodiments are intended as typical of, rather than in any way limiting on, the scope of the present invention as presented in the appended claims.

What is claimed is:

1. An overhead door comprising:
a plurality of unconnected panels, each panel comprising a first and second end; an outer and inner surface; and a top and bottom edge; wherein each top and bottom edge comprises a top edge retention geometry and a bottom edge retention geometry, respectively; the top edge retention geometry engaging and disengaging an adjacent panel bottom edge retention geometry to prevent lateral displacement of the panels when engaged; and
a first and second end cap attached to the respective first and second end; each end cap comprising at an inferior end a retentive member, a bearing receiving geometry, a panel fastening section, a first and second end cap bearing, an adjacent panel slide member receiving section, and a slide member;
wherein
each panel end operatively engages a respective guide assembly;
the plurality of unconnected panels further comprises a bottom panel comprising an operative attachment member;
the guide assembly comprises a vertical section and a horizontal section with a guide assembly radius therebetween; each section comprising a first and second track; and
upon each panel separation a total door weight is reduced by a weight of the separated panel.

2. The overhead door of claim 1 wherein the first and second track are separated from one another by a distance equal to a width of a panel.

3. The overhead door of claim 1 wherein the first and second track are separated from one another in the vertical section by an offset distance between a first engagement member and a second engagement member.

4. The overhead door of claim 1 wherein one edge retention geometry comprises a tongue and the other retention geometry comprises a groove wherein the tongue and respective groove of adjacent panels are angled from normal.

5. The overhead door of claim 4 wherein a tongue angulation and a groove angulation are both about 10 degrees to about 25 degrees.

6. The overhead door of claim 4 wherein a tongue angulation and a groove angulation are both about 18 degrees.

7. The overhead door of claim 1 wherein one edge retention geometry comprises a first stepped geometry and the other retention geometry comprises a second stepped geometry wherein each respective stepped geometry of adjacent panels are angled from respective panel edge normal.

8. The overhead door of claim 4 wherein a tongue angulation and a groove angulation are both about 10 degrees to about 25 degrees.

9. The overhead door of claim 4 wherein a tongue angulation and a groove angulation are both about 18 degrees.

10. The overhead door of claim 1 wherein one edge retention geometry comprises a lip angle and the other retention geometry comprises a trough angle.

11. The overhead door of claim 4 wherein the lip angle and the trough angle are both about 10 degrees to about 25 degrees.

12. The overhead door of claim 4 wherein the lip angle and the trough angle are both about 18 degrees.

13. The overhead door of claim 1 further comprising a thermal break piece attached to each panel.

14. The overhead door of claim 1 wherein the end cap retentive member comprises a hook geometry and the bearing receiving geometry comprises scalloping,

15. The overhead door of claim 14 wherein the hook geometry comprises a hook radius and an engagement leg.

16. The overhead door of claim 1 wherein the first end cap bearing is superior to the second end cap bearing and each bearing is captured by the respective first and second track.

17. The overhead door of claim 16 wherein the first and second bearing are horizontally offset from one another and each bearing has a first bearing end and a second bearing end separated by a bearing groove therebetween; each bearing end captured by a respective first and second guide assembly track chamber.

18. The overhead door of claim 1 wherein the slide member comprises an end cap retentive member engaging end and an end cap retentive member receiver.

19. The overhead door of claim 18 wherein the retentive member engaging end comprises a slide member radius; the retentive member receiver comprises a slide member slot; the end cap further comprises an acute hook disengagement angle; and the slide member further comprises an acute slide member slot angle.

20. The overhead door of claim 19 wherein both the acute hook disengagement angle and the acute slide member slot angle are both between about 65 degrees and about 75 degrees.

21. A door panel comprising:
a first and second end;
an outer and inner surface;
a top and bottom edge; and
a first and second end cap attached to the respective first and second end; each end cap comprising at an inferior end a retentive member, a bearing receiving geometry, a panel fastening section, a first and second end cap bearing, an adjacent panel slide member receiving section, and a slide member;
wherein
each top and bottom edge comprises a top edge retention geometry and a bottom edge retention geometry, respectively; the top edge retention geometry engaging and
disengaging an adjacent panel bottom edge retention geometry to prevent lateral displacement of the panels when engaged;
the end cap retentive member comprises a hook geometry and the bearing receiving geometry comprises scalloping;
the first end cap bearing is superior to the second end cap bearing and the bearings are horizontally offset from one another; and
the slide member comprises an end cap retentive member engaging end and an end cap retentive member receiver.

22. The door panel of claim 21 wherein each bearing has a first bearing end and a second bearing end separated by a bearing groove therebetween.

23. The door panel of claim 21 wherein the retentive member engaging end comprises a slide member radius; the retentive member receiver comprises a slide member slot; the end cap further comprises an acute hook disengagement angle; and the slide member further comprises an acute slide member slot angle.

24. The door panel of claim 23 wherein both the acute hook disengagement angle and the acute slide member slot angle are both between about 65 degrees and about 75 degrees.
